(19) United States
(12) Patent Application Publication
(10) Pub. No.: US 2009/0146963 A1
(43) Pub. Date: Jun. 11, 2009

(54) METHOD FOR DETERMINING MULTIPLE TOUCH INPUTS ON A RESISTIVE TOUCH SCREEN

(75) Inventors: YU-CHOU YEH, Taoyuan Hsien (TW); KUANG-HUEI HUANG, Taoyuan Hsien (TW); MING-JYH SUN, Taoyuan Hsien (TW); YU-HONG YEN, Taoyuan Hsien (TW)

Correspondence Address: WPAT, PC, 7225 BEVERLY ST., ANNANDALE, VA, 22003, US

(73) Assignee: J TOUCH CORPORATION, Taoyuan Hsien (TW)

(21) Appl. No.: 12/016,293

(22) Filed: Jan. 18, 2008

(30) Foreign Application Priority Data
Dec. 11, 2007 (TW) 096147150

(51) Int. Cl. G06F 3/042

(52) U.S. Cl. 345/173

(57) ABSTRACT

The present invention provides a method for determining multiple touch inputs on a resistive touch screen, the method comprises determining a touching sequence between a first object and a second object when the first object and the second object touch the resistive touch screen respectively; calculating coordinate of a first point and coordinate of a actual point according to voltage drop in the resistive touch screen meanwhile the first object keeps touching the resistive touch screen; and determining a control instruction according to movement of the actual point.

### BACKGROUND OF THE INVENTION

1. Field of the Invention

This invention generally relates to a method for determining multiple touch inputs on a resistive touch screen. The invention more particularly relates to a method for determining multiple touch inputs that constitute a gesture on a resistive touch screen.

2. Description of the Related Art

In 1970, touch screen is originated for military usage in United States of America. Until 1980, technologies related to touch screen were published and utilized to be other applications. Now, touch screen is universal and applied to replace input device like keyboard or mouse. Especially, most of electrical equipments such as Automatic Teller Machine (ATM), Kiosks, Point of Service (POS), household appliances, industrial electronics and etc are equipped with touch screen and its technologies to make input easily. In addition, more and more the consumer products take this trend to make them thin, light, short and small to carry, for example, personal digital assistant (PDA), mobile phone, notebook, laptop, MP3 player and so on.

Resistive touch screen is a mainstream in the market because of low cost. Resistive touch screens have a flexible top layer and a rigid bottom layer separated by insulating dots, with the inside surface of each layer coated with a transparent metal oxide. Pressing the flexible top sheet creates electrical contact between the resistive layers, essentially closing a switch in the circuit. The control electronics alternate voltage between the layers to get x then y touch coordinates. However, resistive touch screen has a great disadvantage when it is used to perform multiple touch function, especially the multiple touch points constitutes a gesture. For example, when a user touches the screen on point A and B by two fingers, the flexible top layer may contacts the rigid bottom layer in a line constructed between point A and B, and it causes every points on the line could be determined correct points A and B.

It is understood that the disadvantage of the resistive touch screen is required to improve when the products need multiple touch function. Therefore, the present invention provides a method for determining multiple touch inputs on a resistive touch screen.

### BRIEF SUMMARY OF THE INVENTION

To solve the disadvantage of the prior art. The present invention provides a method for determining multiple touch inputs that constitute a gesture on a resistive touch screen.

The aspect of the present invention is to determine a gesture on the resistive touch screen. The gesture is composed of multiple touch points.

To achieve these aspects mentioned above, the present invention provides a method for determining multiple touch inputs on a resistive touch screen, the method comprises determining a touching sequence between a first object and a second object when the first object and the second object touch the resistive touch screen respectively, calculating coordinate of a first point and coordinate of a actual point according to voltage drop in the resistive touch screen meanwhile the first object keeps touching the resistive touch screen, and determining a control instruction according to movement of the actual point.

The present invention provides a method to determine multiple touches on the resistive screen with several advantages such as simple architecture, elementary theorem, low cost, re-design off and a gesture could be applied to the resistive touch screen.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A, 1B and 1C are schematic diagrams of calculation of coordinate based on an antecedent point according to one embodiment of the present invention;

FIGS. 2A, 2B and 2C are schematic diagrams illustrate how to determine whether a second point is touched on the resistive touch screen according to another embodiment of the present invention;

FIG. 3 is a schematic diagram for illustrating moving trend of multiple touch points on a resistive touch screen according to one embodiment of the present invention;

FIG. 4 is a flow chart for illustrating a control method according to one embodiment of the present invention;

FIG. 5 is a functional diagram of a multiple touch controller according to one embodiment of the present invention; and

FIGS. 6A, 6B and 6C are function diagrams for illustrating signals transmission between several functional blocks disclosed in the flow chart shown in FIG. 4.

### DETAILED DESCRIPTION OF THE INVENTION

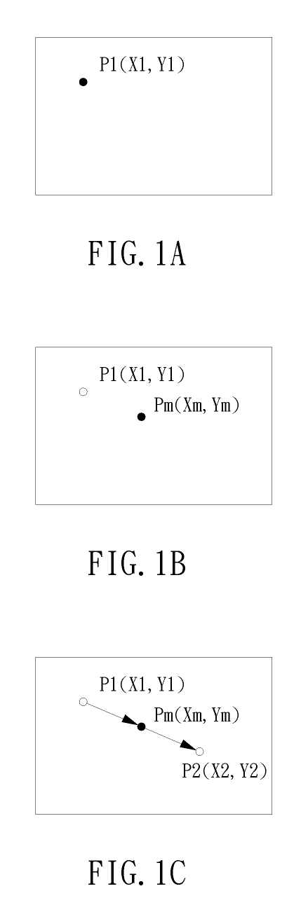

Several exemplary embodiments of the invention are described with reference to FIGS. 1A through 6C, which generally relate to a method for determining multiple touch inputs on a resistive touch screen. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

Referring to FIG. 1A˜1C, they are schematic diagrams of calculation of coordinate based on an antecedent point according to one embodiment of the present invention. In FIG. 1A, an antecedent point P1(X1, Y1) is determined when a finger keeps touching on the restrictive screen. In FIG. 1B, a midpoint Pm is determined by detecting discrete voltage drop between the antecedent point P1 and a second point P2 shown in FIG. 1C. The second point P2 is pressed by another finger after the antecedent point P1. As mentioned above, the system receives two coordinate of points P1 (X1, Y1) and P2(X2, Y2) and calculates coordinate of the point Pm (Xm, Ym) by detecting the voltage drop between P1 and P2.

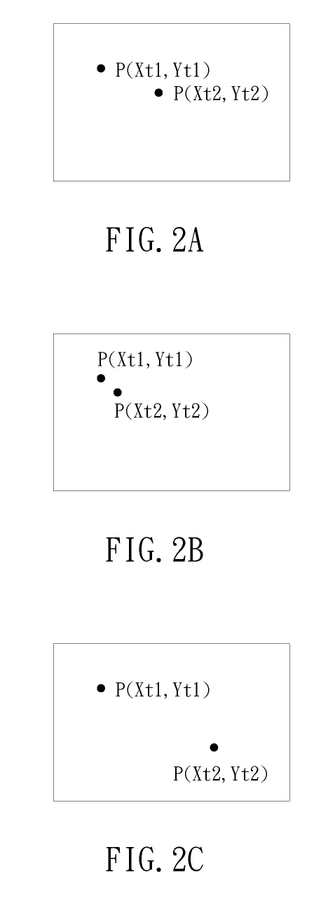

Referring to FIG. 2A˜2C, which are schematic diagrams illustrate how to determine whether a second point is touched on the resistive touch screen according to another embodiment of the present invention, wherein the voltage detecting value is stored in the coordinate register. In FIG. 2A, the system detects a coordinate of point P(Xt1, Yt1) in a time slot T1, and detects a coordinate of point P(Xt2, Yt2) in a time slot T2. If the only one point is determined by the system (i.e. point P1 moves to location of P2), it is said the velocity of the Point P is deemed as

$$V 12 = \frac{\sqrt{{( Xt 2 - Xt 1 )}^{2} + {( Yt 2 - Yt 1 )}^{2}}}{( T 2 - T 1 )} .$$

The system could define V12 is a maximum of moving velocity (Vmax). When the system calculates moving velocity of a first point P1(X1, Y1) is lower than Vmax as shown in FIG. 2B, the system determines that a single point moving. When the system calculates moving velocity of a first point P1(X1, Y1) is higher than Vmax as shown in FIG. 2C, the system determines that a second point being touched.

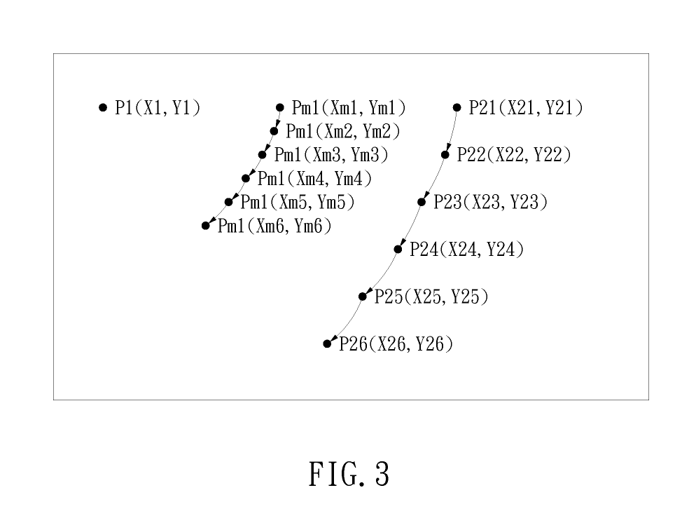

Referring to FIG. 3, it is a schematic diagram for illustrating moving trend of multiple touch points on a resistive touch screen according to one embodiment of the present invention. When a first touch point P1 (X1, Y1) holds on the resistive touch screen and the second touch point moves as points P21 (X21, Y21) to P26 (X26, Y26) on the screen, the system could calculates the voltage detecting value like the moving trend conform to points Pm1 (Xm1, Ym1) to Pm6 (Xm6, Ym6). Therefore, the system could determine the gesture by the moving trend.

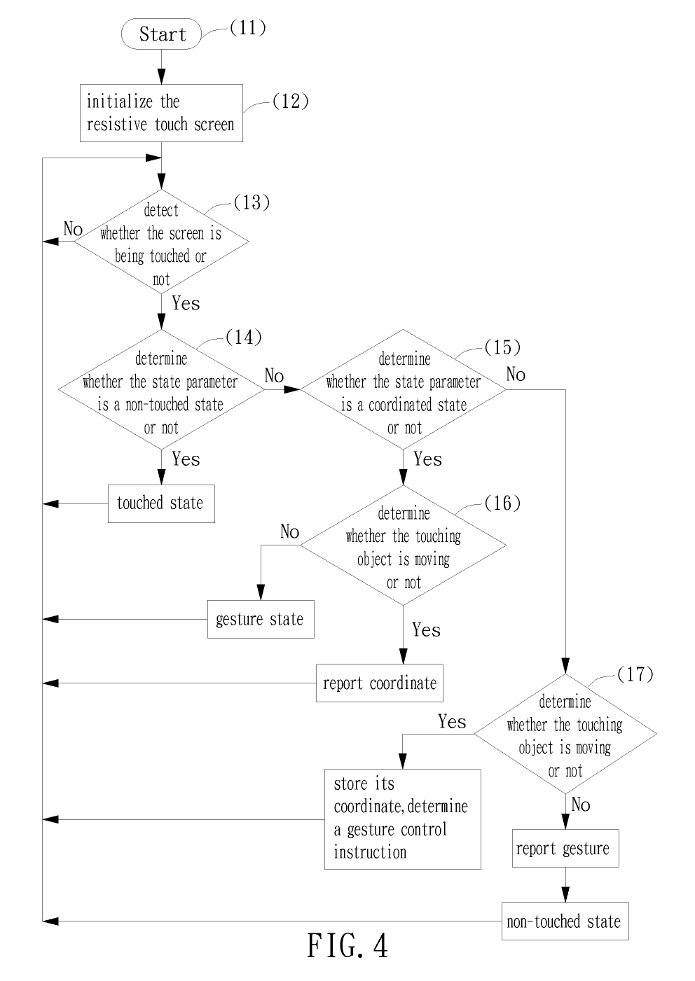

Referring to FIG. 4, it is a flow chart for illustrating a control method according to one embodiment of the present invention. As mentioned above, it is summarized that a flow chart for determining a gesture.

Step S11: start this flow.

Step S12: initialize the resistive touch screen.

Step S13: detect whether the screen is being touched or not, if yes, go to Step 14, if no, go to Step 13.

Step S14: determine whether the state parameter is a non-touched state or not, if yes, set the state parameter to a touched state and go to step S13; if no, go to step S15.

Step S15: determine whether the state parameter is a coordinated state or not, if yes, go to step S16; if no, go to step S17.

Step S16: determine whether the touching object is moving or not, if yes, report its coordinate and go to Step 13; if no, set the state parameter to a gesture state and go to Step 13.

Step S17: determine whether the touching object is moving or not, if yes, store its coordinate, determine a gesture control instruction and go to Step 13; if no, report the gesture, set the state parameter to the non-touched state and go to Step 13.

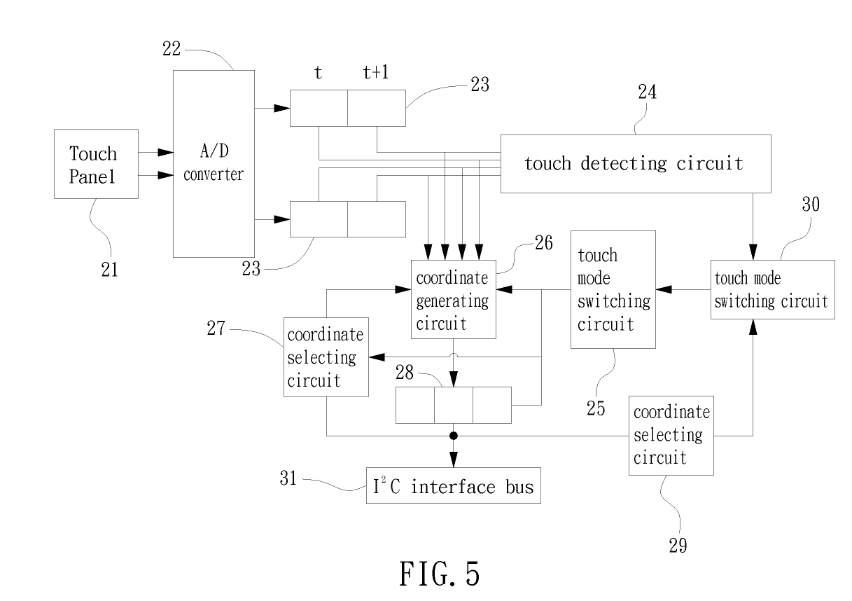

Referring to FIG. 5, it is a functional diagram of a multiple touch controller according to one embodiment of the present invention functional. Also referring to FIG. 4 with FIG. 2. This invention provides a resistive touch screen 21, determines a touching sequence between a first object and a second object when the first object and the second object touch the resistive touch screen respectively, calculates coordinate of a first point P1 (X1, Y1) and at least actual points Pm1 (Xm1, Ym1) to Pm6 (Xm6, Ym6) according to the touching voltage detected by the touch screen 21, meanwhile the first object keeps touching the resistive touch screen, wherein one of the actual point Pm1 (Xm1, Ym1) to Pm6 (Xm6, Ym6) is a point between the first point P1 (X1, Y1) and the second point P21 (X21, Y21)˜P26 (X26, Y26), and determines a control instruction according to moving trace or movement of the actual points Pm1 (Xm1, Ym1) to Pm6 (Xm6, Ym6).

The system includes a resistive touch panel 21 coupled to an analog to digital converter 22 coupled to a first-in-first-out buffer 23, a touch detecting circuit 24, a touch mode switching circuit 25 coupled to a coordinate generating circuit 26, a coordinate selecting circuit 27, a coordinate register 28, a midpoint calculating circuit 29, a coordinate comparing circuit 30 coupled to the touch mode switching circuit 25, and an I²C interface bus 31 coupled to the a coordinate register 28.

The resistive touch panel 21 transmit analog signals to the analog to digital converter 22 for translating analog signals to digital signals, the A/D converter 22 transmits coordinate of X-axis and Y-axis into the first-in-first-out buffer 23. The first-in-first-out buffer 23 includes two columns to store two set of coordinate of points on time t and t+1. If the distance between two points is larger than a predetermined value, it means there are two bodies press on the touch screen and the touch detecting circuit 24 will transmit a status signal to the touch mode switching circuit 25 for identification of the status change. Meanwhile, the coordinate generating circuit 26 calculates coordinate of the new point according to status of the touch mode switching circuit 25, coordinate of the first-in-first-out buffer 23 and coordinate of the coordinate register 28 accessed by the coordinate selecting circuit 27. The value of X-axis and Y-axis stored in the coordinate register 28 is outputted by the I²C interface bus 31. The midpoint calculating circuit 29 is for calculating each of midpoints and transmits information to the coordinate comparing circuit 30 for determining which points is released. The coordinate register 28 could be a right shift register or left shift register for storing coordinate of points. In this embodiment, the coordinate register 28 can store three sets of coordinate, but not limited to. In the architecture mentioned above, the invention utilizes a FIFO buffer 23 to record coordinates which detected by the touch screen 21 in different time slots. The coordinate could be a first point P1 or actual points Pm in different time slots. The FIFO buffer 23 records two coordinates of two actual points. When touching object touches or leaves the touch screen, the change of voltage drop could be detected. By this change, the FIFO buffer 23 could record different actual coordinates, and determine a control instruction such as volume control, songs selection, or rewind according to moving trace of the points Pm1 (Xm1, Ym1) to Pm6 (Xm6, Ym6).

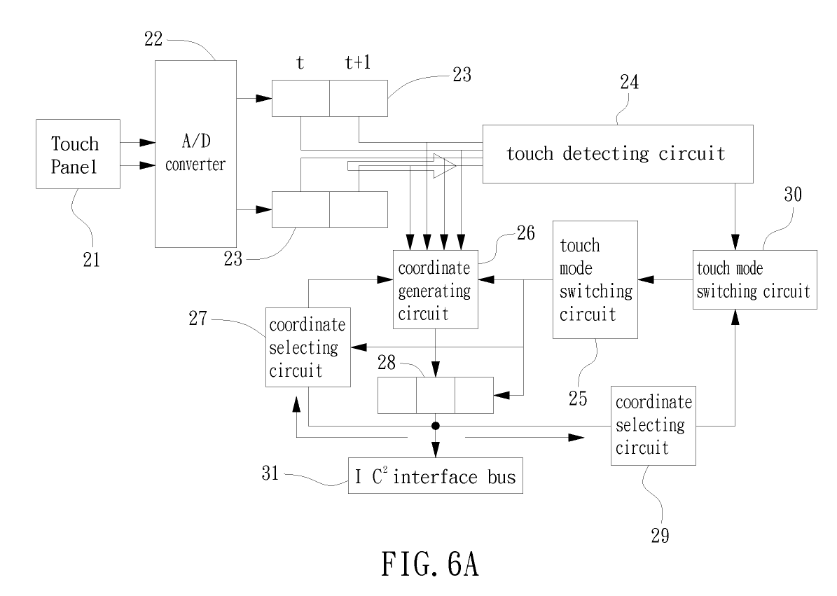

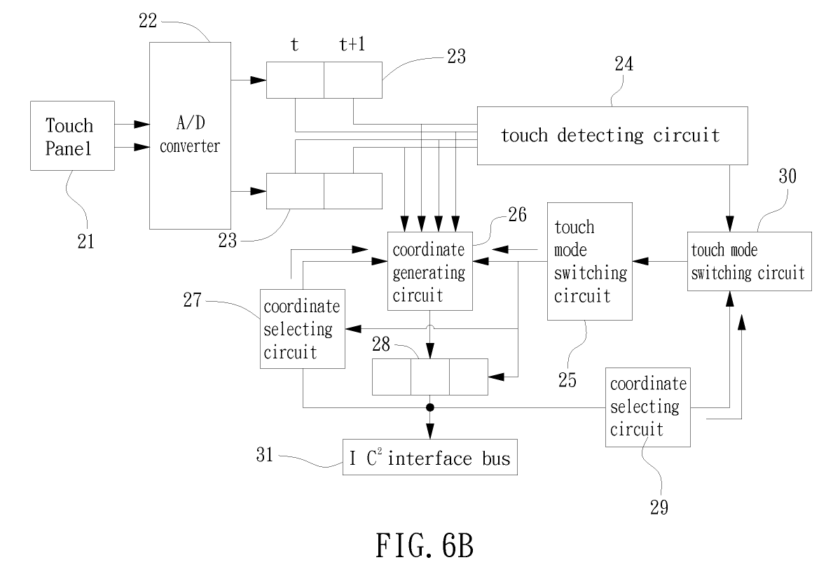

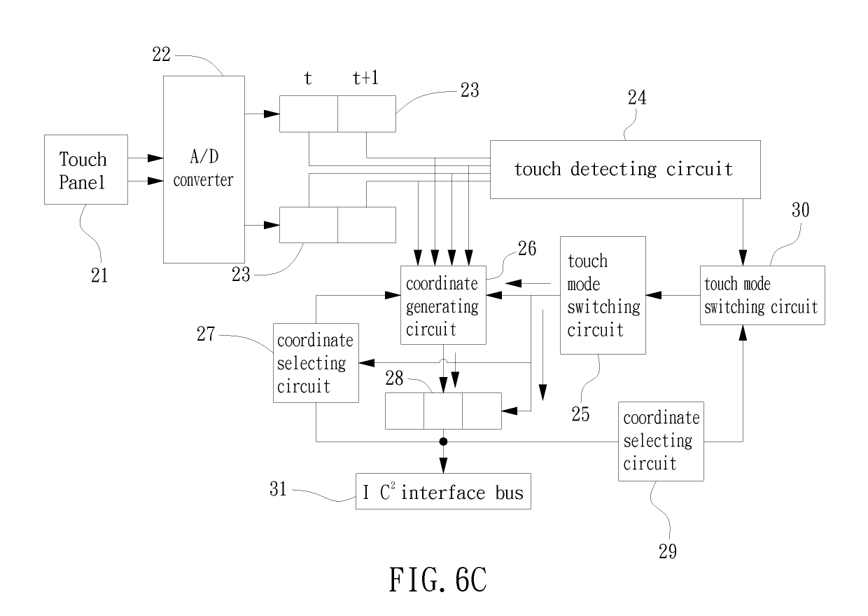

Referring to FIG. 6A˜6C, they are function diagrams for illustrating signals transmission between several functional blocks disclosed in the flow chart shown in FIG. 4.

In FIG. 6A, the value of coordinate is transmitted from the first-in-first-out buffer 23 to the touch detecting circuit 24 and to the coordinate generating circuit 26 for calculation. At the same time, the value of coordinate is transmitted from the coordinate register 28 to the midpoint calculating circuit 29 for calculating coordinate of the current point to the coordinate selecting circuit 27.

In FIG. 6B, the coordinate comparing circuit 30 determines whether any point is released according to information provided by the midpoint calculating circuit 29, and provides information to the touch mode switching circuit 25 for changing status. The coordinate selecting circuit 27 selects proper coordinate according to signals from the touch mode switching circuit 25, to the coordinate generating circuit 26.

In FIG. 6C, the coordinate generating circuit 26 generates the control instruction according to information from the first-in-first-out buffer 23 and the moving trace of Pm1 (Xm1, Ym1) to Pm6 (Xm6, Ym6) provided by the coordinate selecting circuit 27. Then the control instruction is outputted by the I²C interface bus 31.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining multiple touch inputs on a resistive touch screen, the method comprises:
determining a touching sequence between a first object and a second object when the first object and the second object touch the resistive touch screen respectively;
calculating coordinate of a first point and coordinate of an actual point according to voltage drop in the resistive touch screen meanwhile the first object keeps touching the resistive touch screen; and
determining a control instruction according to movement of the actual point.

2. The method as claimed in claim 1, wherein determining the touching sequence is performed by a first-in-first-out (FIFO) buffer.

3. The method as claimed in claim 2, further comprising:
transmitting coordinate of the first point and coordinate of the actual point to a touch detecting circuit and a coordinate generating circuit; and
storing coordinate of the first point and coordinate of the actual point in a coordinate register.

4. The method as claimed in claim 3, further comprising:
transmitting calculated coordinate of the first point and calculated coordinate of the actual point from the coordinate register to a calculating circuit and a coordinate selecting circuit.

5. The method as claimed in claim 4, further comprising:
determining whether having any else touch inputs by a coordinate comparing circuit according to the result of the calculating circuit;
transmitting a status signal by a touching mode selecting circuit; and
transmitting a proper coordinate value to the coordinate generating circuit according to the status signal.

6. The method as claimed in claim 5, wherein the coordinate generating circuit calculates coordinate of a second point according to results from the first-in-first-out buffer and the coordinate selecting circuit, the touch mode switching circuit transmits coordinate of the second point to the coordinate register, outputs coordinate of the second point by an interface bus.

7. The method as claimed in claim 6, wherein the interface bus is a I²C interface or a serial peripheral interface (SPI).

8. The method as claimed in claim 2, wherein the first-in-first-out buffer is capable of storing two sets of coordinate having X-axis and Y-axis.

9. The method as claimed in claim 2, wherein the first-in-first-out buffer is capable of storing more than two sets of coordinate having X-axis and Y-axis.

10. The method as claimed in claim 3, wherein the touch detecting circuit is utilized to access the value in the first-in-first-out buffer, determine whether lager than a threshold, determine whether having any else touch points and outputs a control signal.

11. The method as claimed in claim 10, wherein the touch mode switching circuit is utilized to receive the control signal from the touch detecting circuit for determining status of the touch mode switching circuit.

12. The method as claimed in claim 4, wherein the coordinate generating circuit is utilized to access the first-in-first-out buffer, the coordinate selecting circuit, and status of the touch mode switching circuit to obtain value of X-axis and Y-axis.

13. The method as claimed in claim 3, wherein the coordinate register is capable of storing the value of X-axis and Y-axis transmitted from the coordinate generating circuit.

14. The method as claimed in claim 3, wherein the coordinate selecting circuit is capable of referring the coordinate register and the first-in-first-out buffer at the same time, and calculating coordinate value of the second point.

15. The method as claim in claim 5, wherein the coordinate comparing circuit is utilized to determine whether any touches is released or not and transmit a signal to the touch mode switching circuit.

16. The method as claim in claim 3, wherein the coordinate register is a left-shift register or a right-shift register.
